(19) United States
(12) Patent Application Publication
(10) Pub. No.: US 2008/0006518 A1
(43) Pub. Date: Jan. 10, 2008

(54) Process For Reforming Biomass And Apparatus For Reforming Biomass

(75) Inventors: Mikio Shimojo, Higashiibaraki-gun (JP); Kazunobu Inoue, Yokohama-shi (JP); Masao Tsurui, Higashiibaraki-gun (JP); Yoshinori Suto, Higashiibaraki-gun (JP); Tsutomu Katagiri, Higashiibaraki-gun (JP); Koji Tamura, Higashiibaraki-gun (JP); Fujio Tsuchiya, Higashiibaraki-gun (JP); Katsuaki Osato, Higashiibaraki-gun (JP)

Correspondence Address: DARBY & DARBY P.C., P.O. BOX 770, Church Street Station, New York, NY, 10008-0770, US

(73) Assignee: JGC CORPORATION, Tokyo (JP)

(21) Appl. No.: 11/572,509

(22) PCT Filed: Jul. 20, 2005
(86) PCT No.: PCT/JP05/13337

§ 371 Date: Jan. 23, 2007

(30) Foreign Application Priority Data
Jul. 28, 2004 (JP) 2004-220523

(51) Int. Cl. C10B 53/02; B01J 3/00; C10B 57/02; B09B 3/00

(52) U.S. Cl. 201/20; 201/22; 422/162; 422/189; 422/193; 422/208

(57) ABSTRACT

In the process for reforming a biomass in accordance with the present invention, a mixture of a biomass and water as a raw material is compressed by a compressing pump 2 to be deposited into the inlet side of a circulating pump 43 in a primary reactor 41. The mixture is discharged from the circulating pump 43, conveyed to a heater 45, and then heated at a temperature ranging from 200 to 260° C., and sent to a reacting bath 47. In the reacting bath 47, hemicellulose contained in the biomass dissolves in hot water and subjected to a carbonizing reaction. The mixture derived from the primary reactor 41 is deposited in the inlet side of a circulating pump 44 of a secondary reactor 42, and sent to a heater 46, heated here at a temperature ranging from 270 to 330° C., and sent to the reacting bath 47. In the reacting bath 47, cellulose contained in the biomass dissolves in hot water, and is subjected to a carbonizing reaction.

### TECHNICAL FIELD

The present invention relates to a process for reforming a biomass such as wood etc., by heating the biomass in pressurized hot water to carbonize it, and an apparatus for reforming the biomass.

Priority is claimed on Japanese Patent Application No. 2004-220523 filed Jul. 28, 2004, the content of which is incorporated herein by reference.

### BACKGROUND ART

Various useful methods utilizing hemicellulose or cellulose, which mainly constitute a biomass, have been proposed.

For example, a process for producing alcohols is proposed, which comprises hydrolyzing a biomass with an acid such as sulfuric acid into a monosaccharide such as glucose, and then fermenting the monosaccharide to produce alcohols.

In Japanese Unexamined Patent Application, First Publication No. 2002-59118, a process for recovering and using a gas is disclosed, which comprises heating a wood biomass in pressurized hot water to decompose and extract cellulose, and decomposing the resultant extracted cellulose resolvent with a metallic catalyst into a mixed gas which contains methane, hydrogen, carbon monoxide, etc.

Moreover, in Japanese Unexamined Patent Application, First Publication No. 2003-129069, a process for producing a slurry fuel is disclosed, which comprises heating a wood biomass in pressurized hot water to decompose and extract once hemicellulose and cellulose contained in the wood biomass, and then further polymerizing and carbonizing the resultant resolvent into a carbide to form a slurry fuel from the resultant carbide.

Incidentally, it has been recently found that in the process of producing a slurry fuel by carbonizing, a byproduct having high adherence and tackiness will be produced simultaneously during the heating, in addition to normal carbides, and that the byproduct will be adhered to the inner wall of the reactor, conduits, pumps, etc. If such a byproduct is adhered to the reactor, etc., then the operation and the maintenance of the reforming apparatus will be hindered, thereby causing problems such as making it difficult to operate the reforming apparatus continuously for a long period.

As a result of analysis, it has been revealed that the byproduct had a comparatively large molecular weight in the order of more than tens of thousands and a small value in terms of the acetone-soluble content. On the other hand, it has been revealed that a normal carbide is a mixture of those having a molecular weight in the order of hundreds and those having a molecular weight in the order of tens of thousands, and that a normal carbide has a value of an acetone-soluble content of approximately 50%.

[Patent document 1]

Japanese Unexamined Patent Application, First Publication No. 2002-59118

[Patent document 2]

Japanese Unexamined Patent Application, First Publication No. 2003-129069

### DISCLOSURE OF INVENTION

Accordingly, it is an object of the present invention to provide a process for reforming a biomass which is capable of suppressing the generation of by-products when heating a biomass such as wood powder in pressurized hot water to carbonize the biomass into a carbide, and an apparatus for reforming the biomass.

### MEANS TO SOLVE THE PROBLEM

In order to attain such an object, a first aspect of the present invention is a process for reforming a biomass by heating the biomass in pressurized hot water to carbonize the biomass, whereby the process includes heating the biomass as a raw material gradually up to a temperature ranging from 270 to 330° C.

A second aspect of the present invention is the process for reforming a biomass as set forth in the first aspect, in which the heating is performed at a rate of not more than 10° C./min.

A third aspect of the present invention is the process for reforming a biomass by heating the biomass in pressurized hot water to carbonize the biomass, whereby the process includes performing a primary heating of the biomass as a raw material gradually at a temperature ranging from 200 to 260° C., and then performing a secondary heating of the biomass at a temperature ranging from 270 to 330° C.

A fourth aspect of the present invention is an apparatus for reforming a biomass by heating the biomass in pressurized hot water to carbonize the biomass, whereby the apparatus includes a tubular reactor which has a first half which serves as a gradual heating part for heating gradually the biomass as a raw material up to a temperature ranging from 270 to 330° C., and a rear half which serves as a temperature maintaining part for maintaining the temperature in a range from 270 to 330° C.

A fifth aspect of the present invention is the apparatus for reforming a biomass as set forth in the fourth aspect, in which the heating in the gradual heating part is performed at a rate of not more than 10° C./min.

A sixth aspect of the present invention is an apparatus for reforming biomass by heating the biomass in pressurized hot water to carbonize the biomass, whereby the apparatus includes a multistage reactor which has n+m (n is an integer of 2 or more, m is an integer of 1 or more) pieces of reactors each of which is connected in series, in which the temperature of each of the reactors ranging from the first step to the nth step is set to be higher sequentially, the temperature of the reactor of (n-1)th step is set to be within a range of 200 to 260° C., the temperature of the reactor of nth step is set to be within a range of 270 to 330° C., and the temperature of the reactors of (n+m)th step or more are set to be within a range of 270 to 330° C.

A seventh aspect of the present invention is an apparatus for reforming a biomass by heating the biomass in pressurized hot water to carbonize the biomass, whereby the apparatus includes a primary reactor which heats the biomass as a raw material at a temperature ranging from 200 to 260° C., and a secondary reactor which heats the biomass discharged from the primary reactor at a temperature ranging from 270 to 330° C.

An eighth aspect of the present invention is the apparatus for reforming biomass as set forth in the seventh aspect, in which at least one of the primary reactor and the secondary reactor is equipped with a circulating circuit for circulating pressurized hot water.

In the present invention, carbonization of a biomass means to decrease the oxygen content from approximately 40 wt % to approximately 20 wt %, and the produced carbide indicates one which has a composition of approximately 75 wt % of carbon, 5 wt % of hydrogen, and 20 wt % of oxygen.

### EFFECT OF THE INVENTION

In accordance with the present invention, generation of by-products can be avoided, and by-products will not be adhered to the inner wall of the reactor etc., thereby it becomes possible to operate an apparatus for reforming continuously over a long period of time.

### BRIEF DESCRIPTION OF THE DRAWINGS

FIG. 1 is a schematic view showing a first example of a reforming apparatus according to the present invention.

FIG. 2 is a schematic view showing a second example of a reforming apparatus according to the present invention.

FIG. 3 is a schematic view showing a third example of a reforming apparatus according to the present invention.

FIG. 4 is a schematic view showing a fourth example of a reforming apparatus according to the present invention.

### BEST MODE FOR CARRYING OUT THE INVENTION

A detailed explanation of the present invention will be given below.

A first embodiment of a process for reforming according to the present invention includes adding a biomass as a raw material into pressurized hot water having a temperature ranging from 20 to 100° C., and gradually heating the pressurized hot water up to a temperature ranging from 270 to 330° C., in which the heating-up rate at that time is set to be 10° C./min or less, preferably 5° C./min or less, and more preferably 3° C./min or less.

A second embodiment of the process for reforming according to the present invention includes performing a primary treatment which adds a biomass as a raw material into pressurized hot water having a temperature ranging from 200 to 260° C. to heat, and then performing a secondary treatment which heats the resultant biomass after performing the primary treatment, at a temperature ranging from 270 to 330° C. The formation of the above by-products can be avoided in the carbonization step by adapting these two embodiments.

When heating a biomass in pressurized hot water, if the temperature ranges from 200 to 260° C., then hemicellulose contained in the biomass will dissolve into the hot water, to be hydrolyzed into a saccharide in which monosaccharides and polysaccharides are mixed, and then this saccharide will be polymerized to form carbides. Moreover, if the temperature ranges from 270 to 330° C., then cellulose contained in the biomass will dissolve into the hot water, to be hydrolyzed into a saccharide in which monosaccharides and polysaccharides are mixed similarly to the above, and then this saccharide will be polymerized to form carbides.

And, as shown in the first embodiment and the second embodiment, if at first carbonization of hemicellulose is performed at a temperature of the pressurized hot water ranging from 200 to 260° C., and thereafter the carbonization of cellulose is performed at a temperature ranging from 270 to 330° C. after the carbonization of this hemicellulose is finished, then by-products will not be generated.

On the other hand, if biomass is subjected to a heat treatment in a pressurized water at a temperature ranging from 270 to 330° C. at a sitting, then by-products will be generated in addition to carbides, and the by-products will be adhered to the inner wall of reactors etc., to form adherent.

Although the reason why by-products are not generated by the first and the second embodiments has not yet been clarified, if the biomass is heated at a sitting at a temperature ranging from 270 to 330° C., then hemicellulose and cellulose will dissolve simultaneously and cause carbonizing reaction simultaneously, which seems to cause ge generation of by-products. However, detailed mechanism thereof has not yet been identified now.

In the first embodiment, if the heating rate is over 10° C./min., then the carbonizing reaction of hemicellulose at a temperature ranging from 200 to 260° C. will not proceed sufficiently and by-products will start to be generated. Moreover, if the final treatment temperature is less than 270° C., then cellulose contained in the biomass will not dissolve, and the carbonizing reaction will not proceed sufficiently. Moreover, if the final treatment temperature is less than 33° C., then the pressure required for maintaining a hot water state will increase (not less than 13 MPa), a larger apparatus will be necessary, and thermal energy loss will occur.

In the second embodiment, if the temperature of the primary treatment is less than 200° C., then hemicellulose contained in the biomass will not dissolve, whereas if the temperature is over 260° C., then hemicellulose and cellulose will dissolve simultaneously. Moreover, if the temperature of the secondary treatment is less than 270° C., then cellulose will not dissolve, and the carbonizing reaction will not proceed sufficiently. On the other hand, if the temperature is over 330° C., then the pressure required for maintaining the hot water state will increase (not less than 13MPa), a larger apparatus will be necessary, and thermal energy loss will occur.

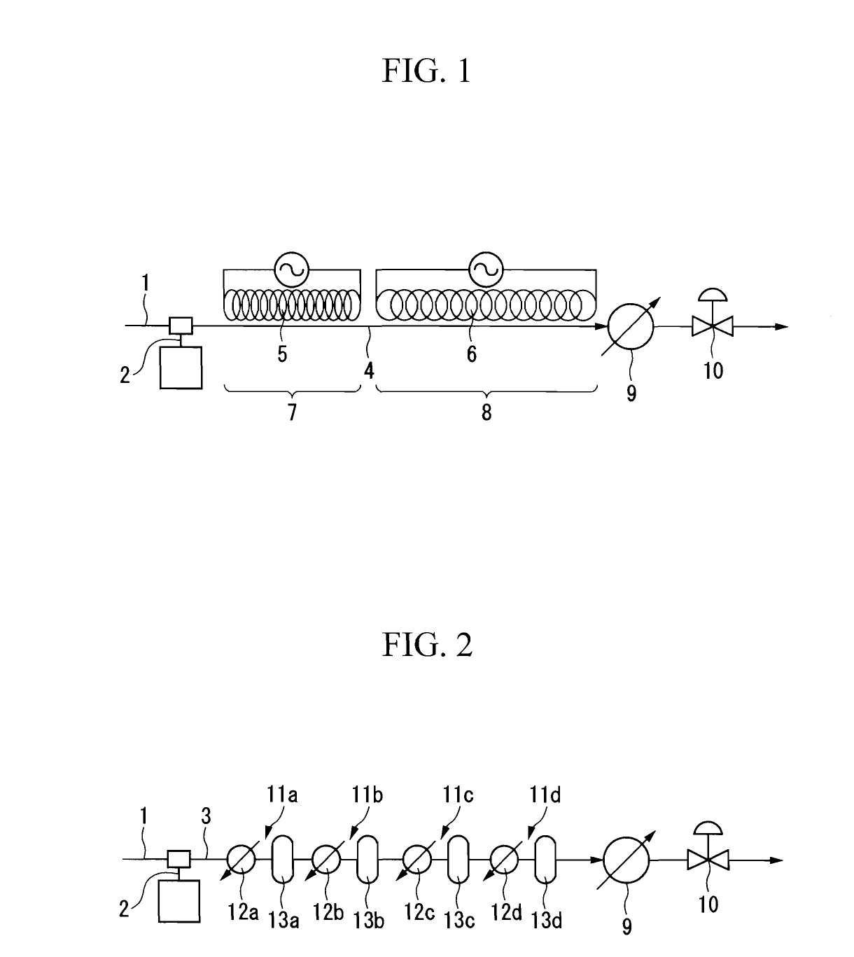

FIG. 1 shows a first example of an apparatus for reforming a biomass in accordance with the present invention, in which a mark 1 denotes a raw material inlet pipe. Into the raw material inlet pipe 1, a mixture of a biomass as a raw material and water is put.

As the biomass referred to here, a biomass of vegetable type, such as wood, bamboo, scrap wood, sawdust, chips, discards, thinnings, rice straw, straw, chaff, bagasse, etc., in the form of a powder having a particle size of not more than 1 cm, preferably not more than 1 mm is used.

The biomass as a raw material and water are mixed with each other within a range of 2 to 15% by weight.

A mixture of the biomass and water as a raw material is conveyed to a compressing pump 2 from the raw material inlet pipe 1, and is compressed so as to be approximately 7 to 15 MPa. The pressure required is one such that the water maintains a liquid state at the temperature required in the heat treatment mentioned later.

The compressed mixture is conveyed to an inlet of a tubular reactor 4. This tubular reactor 4 is, for example, a scale of a demonstrating apparatus being a tubular pressure-proof vessel having an inner diameter ranging from 8 to 25 mm and a length ranging from 100 to 2000 mm, which is equipped with two electric heaters 5 and 6 for heating this, along a longitudinal direction thereof at the periphery. It should be noted that in the case of making these on a commercial scale, it is necessary to investigate whether plural of the same scale apparatus should be equipped or the scale of the apparatus can be magnified. Moreover, as for a heater, it is of course possible for a double-piping heater using a heating medium such as heating oil to be used instead of an electric heater.

A first electric heater 5 on the inlet side of the reactor 4 serves to heat a mixture in the reactor 4 and heat it up gradually from a temperature ranging from 20 to 100° C. up to a final temperature ranging from 270 to 330° C.. The front half on which the first electric heater 5 is disposed serves as a gradually-heating part 7. As mentioned above, the heating rate of the gradually-heating part 7 is controlled to be not more than 10° C./min., preferably not more than 5° C./min., and more preferably not more than 3° C./min.

A second electric heater 6 on the outlet side of the tubular reactor 4 serves to maintain the temperature of the mixture at a temperature ranging from 270 to 330° C., and the rear half of the tubular reactor 4 on which the second electric heater 6 is disposed serves as a temperature-maintaining part 8.

The above mixture after being deposited in the tubular reactor 4 is heated gradually at a low heating rate at the gradually-heating part 7 on the front half thereof, and when the temperature reaches a temperature ranging from 200 to 260° C., hemicellulose will dissolve and then be subjected to the carbonizing reaction described above.

Moreover, when the temperature of the mixture reaches a temperature ranging from 270 to 330° C., the mixture is conveyed from the gradually-heating part 7 disposed at the front half to the heating maintaining part 8 disposed at the rear half and is maintained at this temperature, and cellulose is dissolved here to be subjected to a carbonization reaction.

Subsequently, the reactant discharged from the tubular reactor 4 is conveyed to a cooler 9 and cooled to a suitable temperature here, and then conveyed to a decompressor 10 and reduced to normal pressure to be taken out as a carbide slurry.

In accordance with this reforming apparatus, since hemicellulose and cellulose contained in the biomass will not dissolve simultaneously to be subjected to the carbonizing reaction simultaneously, generation of by-products can be prevented.

FIG. 2 shows a second example of the reforming apparatus according to the present invention, which corresponds to the sixth aspect of the present invention. The reforming apparatus of this example consists of four reactors of 11a, 11b, 11c, and 11d, which are connected in series in a cascade fashion and are constituted such that the above mixture will flow into the rector 11a at the first step, the reactor 11b at the second step, the reactor 11c at the third step, and the reactor 11d at the fourth step, in turn. Each reactor 11 (11a to 11d) consists of a heater 12a, 12b, 12c and 12d for heating the mixture of biomass and water, and reacting bath 13a, 13b, 13c and 13d, respectively.

Each reactor 11(11a to 11d) is controlled such that the temperature of the pressurized hot water increases stepwise from the first step reactor 11a. For example, a mixture of biomass and water supplied at 20° C. is heated to 180° C. in the first step reactor 11a, the resultant mixture is further heated to 230° C. in the second step reactor 11b, the resultant mixture is further heated to 260° C. in the third step reactor 11c, and the resultant mixture is further heated to 300° C. in the fourth step reactor 11d, such that the mixture is heated at each temperature in each reacting bath. In particular, the reacting bath 13d of the fourth step reactor 11d has a volume larger than each former reacting bath, such that the retention time increases to as to heat over a long time period.

The above mixture from the raw material inlet piping 1 is compressed at a pressure ranging from 7 to 15 MPa by the compressing pump, and then heated to a temperature ranging from 20 to 180° C. by a heater 12a of the first step reactor 11a to be subjected to a heat treatment in the reacting bath 13a, and then conveyed to the second step reactor 11b and heated to a temperature ranging from 230° C. by a heater 12b thereof to be subjected to a heat treatment in the reacting bath 13b. And thereafter, the mixture is conveyed to the third step reactor 11c and heated to 260° C. by a heater 12c thereof to be subjected to a heat treatment in the reacting bath 13c. At this time, hemicellulose and cellulose contained in the biomass will dissolve and are subjected to a carbonizing reaction, by the heat treatment at the second step and the third step reactors 11b and 11c.

Subsequently, the resultant mixture conveyed from the third step reactor 11c is heated at 300° C. by a heater 12d of the fourth step reactor 11d to be subjected to a heat treatment in the reacting bath 13d. Here, cellulose contained in the biomass will dissolve to be subjected to a carbonizing reaction. The resultant mixture conveyed from the fourth step reactor 11d is further conveyed to a cooler 9 and cooled to a suitable temperature, and then conveyed to a decompressor 10 and reduced to normal pressure, and taken out as a carbide slurry.

In accordance with this reforming apparatus, since hemicellulose and cellulose contained in biomass will not dissolve simultaneously to be subjected to carbonizing reaction simultaneously, thereby preventing generation of by-products.

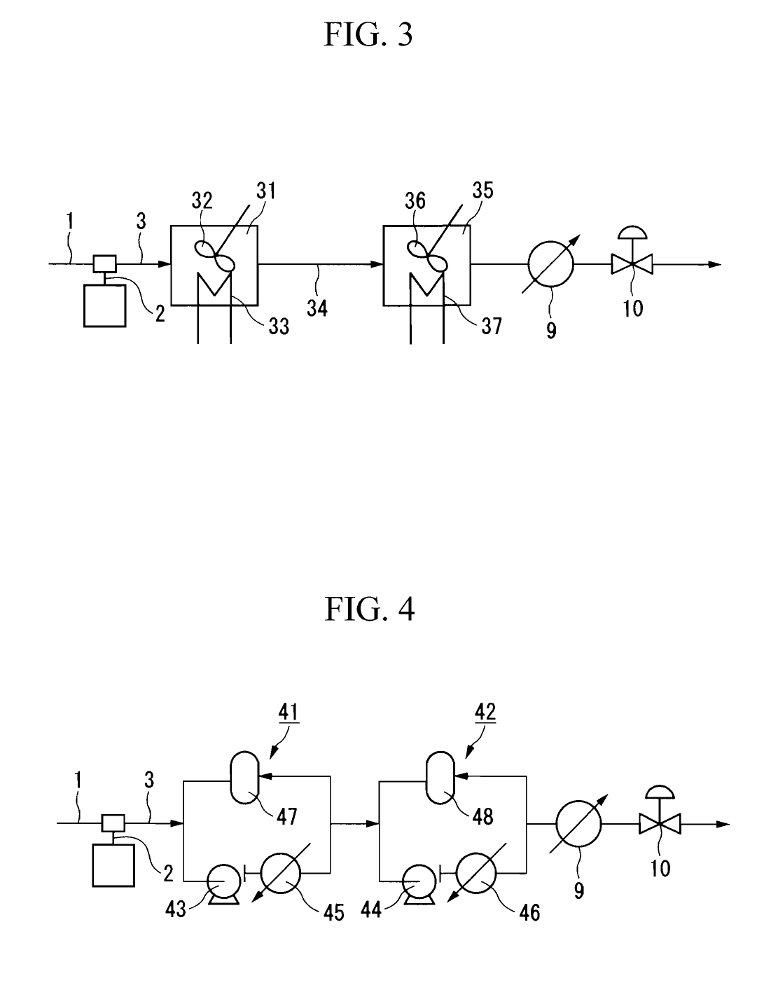

FIG. 3 shows a third example of an apparatus in accordance with the present invention. The above mixture conveyed from the raw material inlet piping 1 is compressed at a pressure ranging from 7 to 15 MPa by the compressing pump 2 to be conveyed to the primary reactor 31 through a pipe 3. The primary reactor 31 is an autoclave, which is equipped with an agitator 32 and a heater 33 therein. The mixture conveyed to the primary reactor 31 is heated by the heater 33 to be a temperature ranging from 200 to 260° C. In the primary reactor 31, hemicellulose contained in the biomass dissolves in hot water to then be subjected to a carbonization reaction.

The mixture subjected to the primary heating treatment in the primary reactor 31 is subsequently conveyed to the secondary reactor 35 through a pipe 34. The secondary reactor 35 is also an autoclave, which is equipped with an agitator 36 and a heater 37 therein.

The mixture conveyed to the secondary reactor 35 is heated by the heater 37 to be a temperature ranging from 270 to 330° C. In the secondary reactor 35, cellulose contained in the biomass dissolves in hot water to then be subjected to a carbonization reaction.

The reactant derived from the secondary reactor 35 is subsequently conveyed to a cooler 9 and cooled to a suitable temperature, and then is conveyed to a decompressor 10 and reduced to normal pressure, and is taken out as a carbide slurry.

In accordance with this reforming apparatus, since hemicellulose and cellulose contained in the biomass will not dissolve simultaneously to be subjected to carbonizing reaction simultaneously, generation of by-products can be prevented.

FIG. 4 shows a fourth example of an apparatus for reforming in accordance with the present invention. The apparatus for reforming of this example is also equipped with a primary reactor 41 and a secondary reactor 42. Each of the primary reactor 41 and the secondary reactor 42 consists of circulating pumps 43, 44 and heaters 45, 46 and reactors 47, 48, being connected by pipes 49 and 50 in series.

And, in each reactor 41 and 42, a circulating circuit is formed, in which the mixture of biomass and water flows from the circulating pumps 43, 44 to the heaters 45, 46, and further to the reacting baths 47,48, and returns from the reacting baths 47, 48 to the circulating pumps 43, 44.

The mixture of biomass and water as a raw material conveyed from the raw material inlet piping 1 is compressed at a pressure ranging from 7 to 15 MPa by a compressing pump 2, and then is deposited into an inlet side of the circulating pump 43 of the primary reactor 41 through a pipe 3. The resultant mixture is discharged by the discharging side of the circulating pump 43, is conveyed to a heater 45, and heated to a temperature ranging from 200 to 260° C., and is conveyed to a reacting bath 47. In the reacting bath 47, hemicellulose contained in the biomass dissolves in hot water, to be then subjected to a carbonization reaction.

The mixture subjected to a carbonizing reaction is returned to the inlet side of the circulating pump 43 from the reacting bath 47 and is subjected to the same heat treatment again by being discharged from the outlet side of the circulating pump 43.

Subsequently, the mixture which is subjected to the heat treatment for a predetermined time in the circulating circuit is drawn from the outlet side of the heater 45 of the primary reactor 41 and then deposited in the inlet side of the circulating pump 44 of the secondary reactor 42 through the pipe 51. The mixture is discharged from the the outlet side of the circulating pump 44 and conveyed to a heater 46 and heated to a temperature ranging from 270 to 330° C. and is conveyed to the reacting bath 47. In the reacting bath 47, cellulose contained in the biomass dissolves in hot water to then be subjected to a carbonizing reaction.

The mixture subjected to a carbonizing reaction is returned to the inlet side of the circulating pump 44 from the reacting bath 48, and is subjected to the same heating treatment again by being discharged from the outlet side of the circulating pump 44.

Subsequently, the mixture which is subjected to the heat treatment for a predetermined time in the circulating circuit is drawn from the outlet side of the heater 46, conveyed to the cooler 9 from a pipe 52, cooled to a suitable temperature, and then reduced to normal pressure by the decompressor 10, and is taken out as a carbide slurry.

In accordance with the apparatus for reforming, since hemicellulose and cellulose contained in the biomass will not dissolve simultaneously and are not subjected to a carbonizing reaction simultaneously, generation of by-products is prevented.

It should be noted that in the apparatus for reforming in the third and the fourth example, the biomass as a raw material may be pushed in the primary reactor using a screw extruder instead of the compressing pump.

Moreover, it is also possible to send the mixture at a temperature ranging from 200 to 260° C. drawn from the primary reactor into a tubular reactor, which is adapted as a secondary reactor, so as to proceed to the reactor by gradually heating up to a temperature ranging from 270 to 330° C.

Experimental examples for confirming the effect of the present invention will be given below. In the following Experimental Examples 1 to 10, experimentation was performed using reaction tubes which correspond to an apparatus for reforming. The reaction tube is made of a stainless steel (SUS 304) having an inner diameter of 8 mm and a length of 700 mm, has a pressure-proof construction, and has a valve equipped on one end thereof by which nitrogen can be passed therethrough. Moreover, the reaction tube can be divided along a longitudinal direction thereof by a screw, and it can accommodate a mesh basket made of stainless steel therein.

In the experimentation, at first, water was poured into a reaction tube so that the depth thereof was 100 mm, a mesh basket filled with cedar sawdust was accommodated therein, and then the reaction tube was closed. Subsequently, nitrogen was added at a pressure of 2 MPa from the valve, and the reaction tube was placed in a heated sand bath to be heated, and when the temperature in the reaction tube reached a predetermined temperature, the mesh basket was placed into water to cause a carbonizing reaction on cedar sawdust.

### EXAMPLE 1

The mesh basket was placed into the water when the temperature of the water in the reaction tube was 25° C., and the temperature was gradually elevated. The heating rate at that time was 3° C./min, and the temperature reached to 300° C. over a heating time of 90 minutes. After holding at this temperature for 10 minutes, the reaction tube was taken out from the heating sand bath, then the reaction tube was cooled, and thereafter the valve was opened to be reduced to normal pressure, and then the reaction tube was opened and the inside was observed.

And as a result, no deposition was observed on the inner wall of the reaction tube and the mesh basket, and cedar sawdust in a carbide state was present in the water.

### EXAMPLE 2

The same operation as in Example 1 was performed with the exception of setting the heating rate to 5° C./min and the heating time to 55 minutes.

And as a result, no deposition was observed on the inner wall of the reaction tube and the mesh basket, and cedar sawdust in a carbide state was present in the water.

### EXAMPLE 3

The same operation as in Example 1 was performed with the exception of setting the heating rate to 10° C./min and the heating time to 28 minutes.

And as a result, no deposition was observed on the inner wall of the reaction tube and the mesh basket, and cedar sawdust in a carbide state was present in the water.

### EXAMPLE 4

The same operation as in Example 1 was performed with the exception of setting the heating rate to 15° C./min and the heating time to 19 minutes.

And as a result, although deposition was observed on the inner wall of the reaction tube and the mesh basket, the quantity thereof was small. Cedar sawdust in a carbide state was present in the water.

### EXAMPLE 5

The same operation as in Example 1 was performed with the exception of setting the heating rate to 20° C./min and the heating time to 14 minutes.

And as a result, a large amount of deposition was observed on the inner wall of the reaction tube and the mesh basket. Cedar sawdust in a carbide state was present in the water.

### EXAMPLE 6

The mesh basket was placed into a water when the temperature of the water in the reaction tube was 200° C., and the temperature was held for 30 minutes, and then the reaction tube was transferred to another heating sand bath which was set at 300° C., and it was kept at this temperature for 30 minutes. And thereafter, the reaction tube was taken out from the heating sand bath, then the reaction tube was cooled, and thereafter the valve was opened to reduce to normal pressure, and then the reaction tube was opened and the inside was observed.

And as a result, no deposition was observed on the inner wall of the reaction tube and the mesh basket, and cedar sawdust in a carbide state was present in the water.

### EXAMPLE 7

The same operation as in Example 6 was performed with the exception of placing the mesh basket into water when the temperature of the water in the reaction tube was 260° C.

And as a result, no deposition was observed on the inner wall of the reaction tube and the mesh basket, and cedar sawdust in a carbide state was present in the water.

### EXAMPLE 8

The same operation as in Example 6 was performed with the exception of placing the mesh basket into water when the temperature of the water in the reaction tube was 180° C.

And as a result, some deposition was observed on the inner wall of the reaction tube and the mesh basket, and cedar sawdust in a carbide state was present in the water.

### EXAMPLE 9

The same operation as in Example 6 was performed with the exception of placing the mesh basket into water when the temperature of the water in the reaction tube was 270° C.

And as a result, some deposition was observed on the inner wall of the reaction tube and the mesh basket, and cedar sawdust in a carbide state was present in the water.

### EXAMPLE 10

The same operation as in Example 6 was performed with the exception of placing the mesh basket into water when the temperature of the water in the reaction tube was 180° C., and transferring the reaction tube to another heating sand bath of which the temperature was set to 260° C.

And as a result, no deposition was observed on the inner wall of the reaction tube and the mesh basket, however, cedar sawdust in state in which carbonization was insufficient was present in the water.

### EXAMPLE 11

Into an autoclave of 1 liter, 50 g of cedar sawdust and 500 g of water were placed, and nitrogen was deposited in the autoclave with a pressure of 2 MPa. While stirring, the mixture was heated gradually using an electric heater up to 300° C. for approximately 60 minutes (at a heating rate of 8° C./min), held for 30 minutes, and then cooled and opened. Black carbide was present in the liquid in the autoclave, deposit onto the stirrer blade and the inner wall of the autoclave was small and it could be easily removed by washing with water.

### EXAMPLE 12

Into an autoclave of 1 liter, 50 g of cedar sawdust and 500 g of water were placed, and nitrogen was deposited in the autoclave with a pressure of 2 MPa. While stirring, the mixture was heated up rapidly with an electric heater at the maximum output, up to 300° C. (at a heating rate of 15° C./min) for approximately 20 minutes, then held for 30 minutes, and thereafter cooled and opened. Black carbide was present in the liquid in the autoclave, and an asphalt-like by-product was adhered to the stirrer blade and the inner wall of the autoclave, which needed to be removed using a metallic spatula.

A belt-like electric heater was wound around a tubular reaction tube having an inner diameter of 8 mm, such that the temperature could be controlled along a longitudinal direction of the reaction tube. A mixture of cedar sawdust and water at normal temperature (sawdust of 5 wt %) was compressed up to 12 MPa using a compressing pump and supplied to the reaction tube. Heating it with the electric heater, the mixture was heated up to 300° C. for approximately 60 minutes at the front half of the reaction tube, and then the mixture was held at 300° C. for 30 minutes at the rear half of the reaction tube, and thereafter cooled with air up to 200° C. and further reduced to normal pressure. After operation for 6 hours, only water being added with compressing, the reaction tube was operated for 2 hours in the same way. During the operation, no increase in pressure at the inlet of the reaction tube was observed. And thereafter, the reaction tube was cut and the interior thereof was inspected, and as a result, little deposit was observed.

### EXAMPLE 14

A belt-like electric heater was wound around a tubular reaction tube having an inner diameter of 8 mm, such that the temperature could be controlled along a longitudinal direction of the reaction tube. A mixture of cedar sawdust and water at normal temperature (sawdust of 5 wt %) was compressed up to 12 MPa using a compressing pump and supplied to the reaction tube. Heating it with the electric heater, the mixture was heated up to 300° C. for approximately 60 minutes at the front half of the reaction tube, and then the mixture was held at 300° C. for 30 minutes at the rear half of the reaction tube, and thereafter cooled with air to 200° C. and further reduced to normal pressure. After operation for 6 hours, only water being added with compressing, the reaction tube was operated for 2 hours in the same way.

During the operation, the pressure at the inlet of the reaction tube increased gradually, and became 15 MPa when it was stopped. And thereafter, the reaction tube was cut and the interior thereof was inspected, and as a result, deposit in an amount of nearly filling the reaction tube was observed at the front half of the reaction tube.

### EXAMPLE 15

An apparatus for reforming shown in FIG. 4 was used. In the primary reactor 41, pressurized hot water was circulated under the conditions of a temperature of 230° C. and an average holding time of 30 minutes. Cedar sawdust was supplied to the primary reactor 41 using a twin-screw extruder and then circulated. Subsequently, the resultant mixture of sawdust and water derived from the primary reactor 41 was supplied to the secondary reactor 42, and was circulated to initiate a carbonizing reaction. After the reaction was completed, no deposit was observed in the primary reactor 41 or the secondary reactor 42.

### EXAMPLE 16

In the primary reactor 41 of the apparatus for reforming shown in FIG. 4, pressurized hot water was circulated under the conditions of a temperature of 300° C. and an average holding time of 60 minutes. Cedar sawdust was supplied to the primary reactor 41 using a twin-screw extruder and then circulated. This was carried out for approximately 10 hours, in the meantime the circulating amount gradually decreased, and at last it became impossible to circulate. When the apparatus was opened and inspected, 2 to 3 mm of deposit was generated at the part in contact with the liquid. The product obtained had an appearance as though it had melted.

### INDUSTRIAL APPLICABILITY

The present invention is applicable to a process for reforming a biomass which includes heating a biomass such as wood etc., in pressurized hot water to carbonize, and an apparatus for reforming a biomass.

1. A process for reforming a biomass by heating the biomass in pressurized hot water to carbonize the biomass, comprising heating the biomass as a raw material gradually up to a temperature ranging from 270 to 330° C.

2. The process for reforming a biomass as set forth in claim 1, wherein said heating is performed at a rate of not more than 10° C./min.

3. A process for reforming a biomass by heating the biomass in pressurized hot water to carbonize the biomass, comprising performing a primary heating of the biomass as a raw material gradually at a temperature ranging from 200 to 260° C., and then performing a secondary heating of said biomass at a temperature ranging from 270 to 330° C.

4. An apparatus for reforming a biomass by heating the biomass in pressurized hot water to carbonize the biomass, comprising a tubular reactor which comprises: a first half which serves as a gradual heating part for gradually heating the biomass as a raw material up to a temperature ranging from 270 to 330° C., and an end half which serves as a temperature maintaining part for maintaining the temperature at a range from 270 to 330° C.

5. The apparatus for reforming a biomass as set forth in claim 4, wherein said heating in said gradual heating part is performed at a rate of not more than 10° C./min.

6. An apparatus for reforming a biomass by heating the biomass in pressurized hot water to carbonize the biomass, comprising a multistage reactor which comprises: n+m (n is an integer of 2 or more, m is an integer of 1 or more) pieces of reactors each of which is connected in series, in which the temperature of each of the reactors ranging from the first step to the nth step is set to be higher sequentially, the temperature of the reactor of (n-1)th step is set to be within a range of 200 to 260° C., the temperature of the reactor of nth step is set to be within a range of 270 to 330° C., and the temperature of the reactors of (n+m)th step or more are set to be within a range of 270 to 330° C.

7. An apparatus for reforming a biomass by heating the biomass in pressurized hot water to carbonize the biomass, comprising a primary reactor which heats said biomass as a raw material at a temperature ranging from 200 to 260° C., and a secondary reactor which heats the biomass discharged from the primary reactor at a temperature ranging from 270 to 330° C.

8. The apparatus for reforming a biomass as set forth in claim 7, wherein at least one of said primary reactor and said secondary reactor is equipped with a circulating circuit for circulating pressurized hot water.
